(19) United States
(12) Patent Application Publication
(10) Pub. No.: US 2021/0351553 A1
(43) Pub. Date: Nov. 11, 2021

(54) TERMINAL PIN DEVICE

(71) Applicant: SUZHOU HARMONTRONICS AUTOMATION TECHNOLOGY CO., LTD., Suzhou, Jiangsu (CN)

(72) Inventors: Hongjian YANG, Suzhou, Jiangsu (CN); Jiadan LI, Suzhou, Jiangsu (CN); Junchen LI, Suzhou, Jiangsu (CN); Xuefeng ZHU, Suzhou, Jiangsu (CN); Fengjie ZHENG, Suzhou, Jiangsu (CN)

(21) Appl. No.: 17/309,021

(22) PCT Filed: Feb. 21, 2019
(86) PCT No.: PCT/CN2019/075652

§ 371 Date: Apr. 14, 2021

(30) Foreign Application Priority Data
Dec. 11, 2018 (CN) 201811501007.6

(51) Int. Cl. H01R 43/16; H01R 43/22

(52) U.S. Cl. CPC H01R 43/16; H01R 43/22

(57) ABSTRACT

Terminal pin device are described herein. The Terminal pin device of the invention comprises a cam box, a cutting mechanism, a material clamping mechanism, a pin inserting mechanism and a cam driving mechanism. The cutting mechanism, the material clamping mechanism, the pin inserting mechanism and the cam driving mechanism are connected with the cam box, and the cam driving mechanism drives the cutting mechanism, the material clamping mechanism and the pin inserting mechanism to operate, so as to realize the integrated terminal cutting, the terminal material clamping and the terminal rotation and terminal pin inserting actions.

### FIELD

The disclosure relates generally to the field of terminal part processing equipment, specific examples relate to the field of cam type Terminal pin devices.

### BACKGROUND

In the field of terminal parts processing, the traditional way is to insert the terminal into the workpiece manually. In the process of manual processing, it is easy to cause the problems of terminal deformation, missing insertion of terminals, irregular arrangement of insertion terminals and so on, resulting in the problem of bad products.

Nowadays, connector as an indispensable part of electronic equipment, its market demand is growing rapidly with the rapid growth of consumer electronics, automotive electronics and communication terminal market. And because many products need to face the development trend of smaller and lighter, which makes the terminal spacing and appearance size, height have certain requirements, which puts forward higher requirements for the development and application of connector to miniaturization and high density.

Obviously, the traditional way of inserting the terminal into the workpiece manually can not meet the current processing requirements of miniaturization and high density terminal.

### BRIEF SUMMARY OF EXAMPLES

The purpose of the invention is to overcome the shortcomings of the prior art, and to provide a Terminal pin device with high processing precision, high speed and high production efficiency, which can complete terminal cutting, terminal clamping and terminal insertion pin action in an integrated way.

To achieve the above purpose, the terminal pin device of the invention comprises a cam box, a cutting mechanism, a material clamping mechanism, a pin inserting mechanism and a cam driving mechanism, and the cutting mechanism, the material clamping mechanism, the pin inserting mechanism and the cam driving mechanism are connected with the cam box.

The cutting mechanism comprises a first cutting slider, a first cutting connecting rod, a first swing rod, a first cutting knife, a second cutting slider, a second cutting connecting rod, a second swing rod and a second cutting knife, the first cutting slider, the first swing rod and the first cutting knife are connected with the cam box, the first cutting slider is connected with the first swing rod through the first cutting connecting rod, and the first swing rod is connected with the first cutting knife, the second cutting slider, the second swing rod and the second cutting knife are connected with the cam box, the second cutting slider is connected with the second swing rod through the second cutting connecting rod, and the second swing rod is connected with the second cutting knife, so that when the first cutting slider and the second cutting slider slide, they will drive the first cutting connecting rod and the second cutting connecting rod to move and then drive the first swing rod and the second swing rod to move. The first swing rod and the second swing rod will drive the first cutting knife and the second cutting knife to move, and the movement of the first cutting knife and the second cutting knife will complete the cutting action of the terminal.

The material clamping mechanism comprises a first material clamping slider, a first material clamping connecting rod, a first clamping claw driving block, a second material clamping slider, a second material clamping connecting rod and a second clamping claw driving block, the first material clamping slider and the first clamping claw driving block are connected with the cam box, the first material clamping slider and the first clamping claw driving block are connected through the first material clamping connecting rod, and the second material clamping slider and the second clamping claw driving block are connected with the cam box, and the second material clamping slider is connected with the second clamping claw driving block through the second material clamping connecting rod, so that when the first material clamping slider and the second material clamping slider slide, they will drive the first material clamping connecting rod and the second material clamping connecting rod to move, and then drive the first clamping claw driving block and the second clamping claw driving block to move.

The pin inserting mechanism comprises a pin slider, a T-shaped connecting plate, a pin pressing rod, a first pin connecting rod, a second pin connecting rod, a first clamping claw, a second clamping claw, a push rod pressing block, a first pin push rod and a second pin push rod, the pin slider and the push rod pressing block are connected with the cam box, the pin pressing rod is fixed on the pin slider, the T-shaped connecting plate is fixed on the pin slider, the first pin connecting rod is slidably connected with the first claw driving block and connected with the T-shaped connecting plate, the second pin connecting rod is slidably connected with the second claw driving block and connected with the T-shaped connecting plate, the first clamping claw is hinged with the first pin connecting rod, the second clamping claw is hinged with the second pin connecting rod, the first pin push rod is sliding connected with the first pin connecting rod and connected with the first clamping claw, the second pin push rod is sliding connected with the second pin connecting rod and connected with the second clamping claw, a spring is arranged between the first pin connecting rod and the first pin push rod, and a spring is arranged between the second pin connecting rod and the second pin push rod, so that when the pin slider slides, the T-shaped connecting plate will be driven to move, and then the first pin connecting rod and the second pin connecting rod will be driven to move. At the initial stage of the movement of the first pin connecting rod and the second pin connecting rod, the first clamping claw and the second clamping claw will be driven to rotate. Then when the push rod pressing block slides, it will drive the first pin push rod and the second pin push rod to move, the movement of the first pin push rod and the second pin push rod will cooperate with the first pin connecting rod and the second pin connecting rod to drive the first clamping claw and the second clamping claw to move downward, the sliding of the pin slider also drives the pin pressing rod to move downward, the movement of the first claw driving block and the second claw driving block also drives the first pin connecting rod and the second pin connecting rod to move in the horizontal direction, the movement of the first pin connecting rod and the second pin connecting rod in the horizontal direction will drive the first clamping claw and the second clamping claw to complete the terminal clamping action, the movement of the first clamping claw, the second clamping claw and the pin pressing rod in the vertical direction completes the terminal insertion pin action.

The cam driving mechanism comprises a motor, a driving shaft, a pin cam, a first cutting cam, a second cutting cam, a first clamping cam, a second clamping cam and a push rod pressing block driving cam, the motor is connected with the cam box, the drive shaft is connected with the motor, the pin cam, the first cutting cam, the second cutting cam, the first clamping cam, the second clamping cam, and the push rod pressing block drive cam are connected with the drive shaft, the pin cam is connected with the pin slider, and the first cutting cam is connected with the first cutting slider, the second cutting cam is connected with the second cutting slider, the first clamping cam is connected with the first material clamping slider, the second clamping cam is connected with the second material clamping slider, and the push rod pressing block driving cam is connected with the push rod pressing block, so that the rotation of the pin cam will drive the pin slider to slide, and the rotation of the first cutting cam will drive the first cutting slider to slide, the rotation of the second cutting cam will drive the second cutting slider to slide, the rotation of the first clamping cam will drive the first material clamping slider to slide, the rotation of the second clamping cam will drive the second material clamping slider to slide, and the push rod pressing block driving cam will drive the push rod pressing block to slide.

Preferably, in the terminal pin device of the invention, the first cutting connecting rod, the second cutting connecting rod, the first material clamping connecting rod and the second material clamping connecting rod all include a connecting rod length adjusting mechanism, so that the relative positions of the first cutting knife, the second cutting knife, the first clamping claw and the second clamping claw can be adjusted by adjusting the connecting rod length adjusting mechanism, so as to ensure the quality of the terminal insertion pin action.

Preferably, the terminal pin device of the invention also includes a hand wheel, which is rotatably fixed on the cam box and connected with the driving shaft, so that the terminal insertion pin action can be driven by shaking the hand wheel for fine adjustment.

Preferably, for the terminal pin device of the invention, the pin pressing rod further comprises a pin pressing rod seat, a pressure sensor and a firing pin, the pin pressing rod seat is fixed on the pin slider, the pressure sensor is fixed on the pin pressing rod seat, and the firing pin is fixed on the pressure sensor, so that the pressure of the pin in the whole terminal insertion pin action can be monitored in real time by the pressure sensor.

The working process of the terminal pin device disclosed by the invention is that the motor drives the drive shaft to rotate, the drive shaft will drive the pin cam, the first cutting cam, the second cutting cam, the first clamping cam, the second clamping cam and the push rod pressing block driving cam to rotate, the first cutting cam and the second cutting cam will drive the cutting mechanism to position and cut the terminal, and then the first clamping cam and the second clamping cam will drive the material clamping mechanism to clamp the terminal, after the terminal is clamped by the material clamping mechanism, the cutting mechanism will reset to make way for the terminal insertion pin action, driven by the pin cam and the push rod pressing block driving cam, the pin inserting mechanism will rotate the terminal angle and insert the pin into the terminal, after the terminal insertion pin action is completed, the pin inserting mechanism will reset, and then move the next step One cycle action, and then run the action of the next cycle, so as to achieve the integration of terminal cutting, terminal clamping and terminal insertion pin action.

Additional understanding of the claimed terminal pin device can be obtained by reviewing the detailed description of selected examples, below, with reference to the appended drawings.

### DESCRIPTION OF THE DRAWINGS

FIG. 1 is a front view of the terminal pin device of the present invention.

FIG. 2 is A-A sectional view of the terminal pin device of the present invention.

FIG. 3 is a front view of the cam group of the terminal pin device of the present invention.

FIG. 4 is a schematic diagram of the terminal angle rotation of the terminal pin device of the present invention.

In the figure: 1. Cam box; 2. Pin slider; 3. First cutting slider; 4. T-shaped connecting plate; 5. pin pressing rod; 6. First material clamping slider; 7. First pin connecting rod; 8. Push rod pressing block; 9. First cutting connecting rod; 10. First material clamping connecting rod; 11. First swing rod; 12. First cutting knife; 13. First clamping claw driving block; 14. First pin push rod; 15. First clamping claw; 16. Second clamping claw; 17. Second cutting knife; 18. Second swing rod; 19. Second pin push rod; 20. Second claw driving block; 21. Second material clamping connecting rod; 22. Second cutting connecting rod; 23. Second pin connecting rod; 24. Second material clamping slider; 25. Second cutting slider; 26. Hand wheel; 27. Motor; 28. Spring; 29. Terminal; 30. Drive shaft; 31. Pin cam; 32. First cutting cam; 33. Second cutting cam; 34. First clamping cam; 35. Second clamping cam; 36. Push rod pressing block driving cam; 51. Pin pressing rod seat; 52. Pressure sensor; 53. Firing pin.

### DESCRIPTION OF EMBODIMENTS

In order to better understand the technical solution of the invention, a preferred embodiment provided by the invention will be described in detail in combination with the drawings of the specification. The description and drawings are provided to enable one skilled in the art to make and use one or more example terminal pin devices. They are not intended to limit the scope of the claims in any manner.

The terminal pin device of the invention comprises a cam box, a cutting mechanism, a material clamping mechanism, a pin inserting mechanism and a cam driving mechanism, and the cutting mechanism, the material clamping mechanism, the pin inserting mechanism and the cam driving mechanism are connected with the cam box.

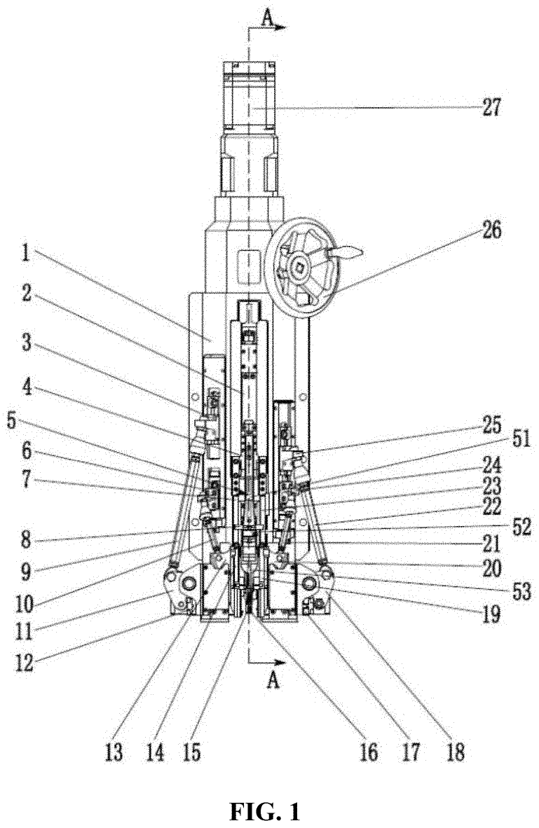

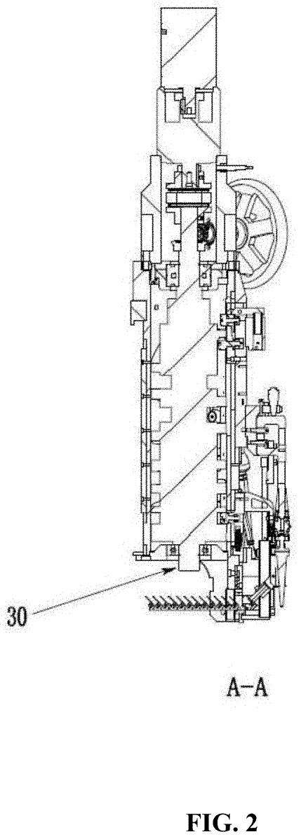

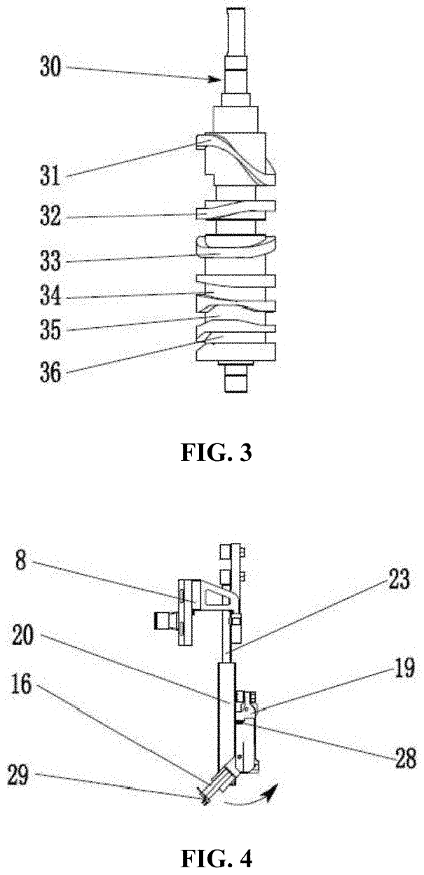

As shown in FIG. 1, the cutting mechanism comprises a first cutting slider 3, a first cutting connecting rod 9, a first swing rod 11, a first cutting knife 12, a second cutting slider 25, a second cutting connecting rod 22, a second swing rod 18 and a second cutting knife 17, the first cutting slider 3, the first swing rod 11 and the first cutting knife 12 are connected with the cam box 1, the first cutting slider 3 is connected with the first swing rod 11 through the first cutting connecting rod 9, and the first swing rod 11 is connected with the first cutting knife 12, the second cutting slider 25, the second swing rod 18 and the second cutting knife 17 are connected with the cam box 1, the second cutting slider 25 is connected with the second swing rod 18 through the second cutting connecting rod 22, and the second swing rod 18 is connected with the second cutting knife 17, so that when the first cutting slider 3 and the second cutting slider 25 slide, they will drive the first cutting connecting rod 9 and the second cutting connecting rod 22 to move and then drive the first swing rod 11 and the second swing rod 18 to move. The first swing rod 11 and the second swing rod 18 will drive the first cutting knife 12 and the second cutting knife 17 to move, and the movement of the first cutting knife 12 and the second cutting knife 17 will complete the cutting action of the terminal 29.

As shown in FIG. 1, the material clamping mechanism comprises a first material clamping slider 6, a first material clamping connecting rod 10, a first clamping claw driving block 13, a second material clamping slider 24, a second material clamping connecting rod 21 and a second clamping claw driving block 20, the first material clamping slider 6 and the first clamping claw driving block 13 are connected with the cam box 1, the first material clamping slider 6 and the first clamping claw driving block 13 are connected through the first material clamping connecting rod 10, and the second material clamping slider 24 and the second clamping claw driving block 20 are connected with the cam box 1, and the second material clamping slider 24 is connected with the second clamping claw driving block 20 through the second material clamping connecting rod 21, so that when the first material clamping slider 6 and the second material clamping slider 24 slide, they will drive the first material clamping connecting rod 10 and the second material clamping connecting rod 21 to move, and then drive the first clamping claw driving block 13 and the second clamping claw driving block 20 to move.

As shown in FIG. 1, 4, the pin inserting mechanism comprises a pin slider 2, a T-shaped connecting plate 4, a pin pressing rod 5, a first pin connecting rod 7, a second pin connecting rod 23, a first clamping claw 15, a second clamping claw 16, a push rod pressing block 8, a first pin push rod 14, a second pin push rod 19 and springs 28, the pin slider 2 and the push rod pressing block 8 are connected with the cam box 1, the pin pressing rod 5 is fixed on the pin slider 2, the T-shaped connecting plate 4 is fixed on the pin slider 2, the first pin connecting rod 7 is slidably connected with the first claw driving block 13 and connected with the T-shaped connecting plate 4, the second pin connecting rod 23 is slidably connected with the second claw driving block 20 and connected with the T-shaped connecting plate 4, the first clamping claw 15 is hinged with the first pin connecting rod 7, the second clamping claw 16 is hinged with the second pin connecting rod 23, the first pin push rod 14 is sliding connected with the first pin connecting rod 7 and connected with the first clamping claw 15, the second pin push rod 19 is sliding connected with the second pin connecting rod 23 and connected with the second clamping claw 16, a spring 28 is arranged between the first pin connecting rod 7 and the first pin push rod 14, and a spring 28 is arranged between the second pin connecting rod 23 and the second pin push rod 19, so that when the pin slider 2 slides, the T-shaped connecting plate 4 will be driven to move, and then the first pin connecting rod 7 and the second pin connecting rod 23 will be driven to move. At the initial stage of the movement of the first pin connecting rod 7 and the second pin connecting rod 23, the first clamping claw 15 and the second clamping claw 16 will be driven to rotate. Then when the push rod pressing block 8 slides, it will drive the first pin push rod 14 and the second pin push rod 19 to move, the movement of the first pin push rod 14 and the second pin push rod 19 will cooperate with the first pin connecting rod 7 and the second pin connecting rod 23 to drive the first clamping claw 15 and the second clamping claw 16 to move downward, the sliding of the pin slider 2 also drives the pin pressing rod 5 to move downward, the movement of the first claw driving block 13 and the second claw driving block 20 also drives the first pin connecting rod 7 and the second pin connecting rod 23 to move in the horizontal direction, the movement of the first pin connecting rod 7 and the second pin connecting rod 23 in the horizontal direction will drive the first clamping claw 15 and the second clamping claw 16 to complete the clamping action of the terminal 29, the movement of the first clamping claw 15, the second clamping claw 16 and the pin pressing rod 5 in the vertical direction completes the insertion pin action of the terminal 29. The first clamping claw 15 and the second clamping claw 16 mainly play the role of clamping and positioning the terminal 29 in the process of action. The direct downward movement force of the pin pressing rod 5 completes the downward insertion of the terminal 29.

As shown in FIG. 1,2,3, the cam driving mechanism comprises a motor 27, a driving shaft 30, a pin cam 31, a first cutting cam 32, a second cutting cam 33, a first clamping cam 34, a second clamping cam 35 and a push rod pressing block driving cam 36, the motor 27 is connected with the cam box 1, the drive shaft 30 is connected with the motor 27, the pin cam 31, the first cutting cam 32, the second cutting cam 33, the first clamping cam 34, the second clamping cam 35, and the push rod pressing block drive cam 36 are connected with the drive shaft 30, the pin cam 31 is connected with the pin slider 2, and the first cutting cam 32 is connected with the first cutting slider 3, the second cutting cam 33 is connected with the second cutting slider 25, the first clamping cam 34 is connected with the first material clamping slider 6, the second clamping cam 35 is connected with the second material clamping slider 24, and the push rod pressing block driving cam 36 is connected with the push rod pressing block 8, so that the rotation of the pin cam 31 will drive the pin slider 2 to slide, and the rotation of the first cutting cam 32 will drive the first cutting slider 3 to slide, the rotation of the second cutting cam 33 will drive the second cutting slider 25 to slide, the rotation of the first clamping cam 34 will drive the first material clamping slider 6 to slide, the rotation of the second clamping cam 35 will drive the second material clamping slider 24 to slide, and the push rod pressing block driving cam 36 will drive the push rod pressing block 8 to slide.

As shown in FIG. 1, in the terminal pin device of the invention, the first cutting connecting rod 9, the second cutting connecting rod 22, the first material clamping connecting rod 10 and the second material clamping connecting rod 21 all include a connecting rod length adjusting mechanism, so that the relative positions of the first cutting knife 12, the second cutting knife 17, the first clamping claw 15 and the second clamping claw 16 can be adjusted by adjusting the connecting rod length adjusting mechanism, so as to ensure the quality of the terminal insertion pin action.

As shown in FIG. 1, the terminal pin device of the invention also includes a hand wheel 26, which is rotatably fixed on the cam box 1 and connected with the driving shaft 30, so that the terminal insertion pin action can be driven by shaking the hand wheel 26 for fine adjustment.

As shown in FIG. 1, for the terminal pin device of the invention, the pin pressing rod 5 further comprises a pin pressing rod seat 51, a pressure sensor 52 and a firing pin 53, the pin pressing rod seat 51 is fixed on the pin slider 2, the pressure sensor 52 is fixed on the pin pressing rod seat 51, and the firing pin 53 is fixed on the pressure sensor 52, so that the pressure of the pin in the whole terminal insertion pin action can be monitored in real time by the pressure sensor 52.

The working process of the terminal pin device disclosed by the invention is that the motor 27 drives the drive shaft 30 to rotate, the drive shaft 30 will drive the pin cam 31, the first cutting cam 32, the second cutting cam 33, the first clamping cam 34, the second clamping cam 35 and the push rod pressing block driving cam 36 to rotate, the first cutting cam 32 and the second cutting cam 33 will drive the cutting mechanism to position and cut the terminal, and then the first clamping cam 34 and the second clamping cam 35 will drive the material clamping mechanism to clamp the terminal, after the terminal is clamped by the material clamping mechanism, the cutting mechanism will reset to make way for the terminal insertion pin action, driven by the pin cam 31 and the push rod pressing block driving cam 36, the pin inserting mechanism will rotate the terminal angle and insert the pin into the terminal, after the terminal insertion pin action is completed, the pin inserting mechanism will reset, and then move the next step One cycle action, and then run the action of the next cycle, so as to achieve the integration of terminal cutting, terminal clamping and terminal insertion pin action.

Those with ordinary skill in the art will appreciate that various modifications and alternative for the described and illustrated embodiments can be developed in light of the overall teachings of the disclosure. Accordingly, the particular arrangements disclosed are intended to be illustrative only and not limiting as to the scope of the invention, which is to be given the full breadth of the appended claims and all equivalents thereof.

What is claimed is:

1. A terminal pin device, comprising:
a cam box, a cutting mechanism, a material clamping mechanism, a pin inserting mechanism and a cam driving mechanism, and the cutting mechanism, the material clamping mechanism, the pin inserting mechanism and the cam driving mechanism are connected with the cam box;
the cutting mechanism comprises a first cutting slider, a first cutting connecting rod, a first swing rod, a first cutting knife, a second cutting slider, a second cutting connecting rod, a second swing rod and a second cutting knife, the first cutting slider, the first swing rod and the first cutting knife are connected with the cam box, the first cutting slider is connected with the first swing rod through the first cutting connecting rod, and the first swing rod is connected with the first cutting knife, the second cutting slider, the second swing rod and the second cutting knife are connected with the cam box, the second cutting slider is connected with the second swing rod through the second cutting connecting rod, and the second swing rod is connected with the second cutting knife;
the material clamping mechanism comprises a first material clamping slider, a first material clamping connecting rod, a first clamping claw driving block, a second material clamping slider, a second material clamping connecting rod and a second clamping claw driving block, the first material clamping slider and the first clamping claw driving block are connected with the cam box, the first material clamping slider and the first clamping claw driving block are connected through the first material clamping connecting rod, and the second material clamping slider and the second clamping claw driving block are connected with the cam box, and the second material clamping slider is connected with the second clamping claw driving block through the second material clamping connecting rod;
the pin inserting mechanism comprises a pin slider, a T-shaped connecting plate, a pin pressing rod, a first pin connecting rod, a second pin connecting rod, a first clamping claw, a second clamping claw, a push rod pressing block, a first pin push rod, a second pin push rod and springs, the pin slider and the push rod pressing block are connected with the cam box, the pin pressing rod is fixed on the pin slider, the T-shaped connecting plate is fixed on the pin slider, the first pin connecting rod is slidably connected with the first claw driving block and connected with the T-shaped connecting plate, the second pin connecting rod is slidably connected with the second claw driving block and connected with the T-shaped connecting plate, the first clamping claw is hinged with the first pin connecting rod, the second clamping claw is hinged with the second pin connecting rod, the first pin push rod is sliding connected with the first pin connecting rod and connected with the first clamping claw, the second pin push rod is sliding connected with the second pin connecting rod and connected with the second clamping claw, a spring is arranged between the first pin connecting rod and the first pin push rod, and a spring is arranged between the second pin connecting rod and the second pin push rod;
the cam driving mechanism comprises a motor, a driving shaft, a pin cam, a first cutting cam, a second cutting cam, a first clamping cam, a second clamping cam and a push rod pressing block driving cam, the motor is connected with the cam box, the drive shaft is connected with the motor, the pin cam, the first cutting cam, the second cutting cam, the first clamping cam, the second clamping cam, and the push rod pressing block drive cam are connected with the drive shaft, the pin cam is connected with the pin slider, and the first cutting cam is connected with the first cutting slider, the second cutting cam is connected with the second cutting slider, the first clamping cam is connected with the first material clamping slider, the second clamping cam is connected with the second material clamping slider, and the push rod pressing block driving cam is connected with the push rod pressing block;

2. The terminal pin device of claim 1, wherein the first cutting connecting rod, the second cutting connecting rod, the first material clamping connecting rod and the second material clamping connecting rod all include a connecting rod length adjusting mechanism.

3. The terminal pin device of claim 1, wherein the terminal pin device also includes a hand wheel, which is rotatably fixed on the cam box and connected with the driving shaft.

4. The terminal pin device of claim 1, wherein the pin pressing rod further comprises a pin pressing rod seat, a pressure sensor and a firing pin, the pin pressing rod seat is fixed on the pin slider, the pressure sensor is fixed on the pin pressing rod seat, and the firing pin is fixed on the pressure sensor.
